(19) United States
(12) Patent Application Publication
(10) Pub. No.: US 2026/0086641 A1
(43) Pub. Date: Mar. 26, 2026

(54) INTERNET OF SENSES IN A COMMUNICATIONS NETWORK

(71) Applicant: Telefonaktiebolaget LM Ericsson (publ), Stockholm (SE)

(72) Inventors: Miguel Angel MUÑOZ DE LA TORRE ALONSO, Madrid (ES); Rodrigo ALVAREZ DOMINGUEZ, Madrid (ES)

(21) Appl. No.: 19/111,008

(22) PCT Filed: Nov. 11, 2022
(86) PCT No.: PCT/EP2022/081581

§ 371 Date: Mar. 12, 2025

(30) Foreign Application Priority Data
Sep. 26, 2022 (EP) 22382882.3

(51) Int. Cl. G06F 3/01; H04W 28/02

(52) U.S. Cl. CPC G06F 3/016; H04W 28/021

(57) ABSTRACT

This disclosure provides a method for handling sensorial information in a communications network. The method comprises transmitting from an application node to a sense device manager sensorial information, an action associated to the sensorial information, and an indication of a target user device for the sensorial information; transmitting from the sense device manager to a user device the sensorial information and the action associated to the sensorial information; and initiating at the user device the action. In some embodiments, the method further comprises transmitting from the user device to the sense device manager capability information on at least one sensorial information supported by the user device; and transmitting from the sense device manager to the user device sensorial information based on the capability information transmitted by the user device.

### TECHNICAL FIELD

The present invention generally relates to the collaboration of applications and communications or mobile networks, and more specifically, the invention relates to the collaboration of Internet of Sense applications and 3GPP mobile networks.

### BACKGROUND

In 3GPP Fifth Generation (5G) networks, the Application Function (AF) interacts with the 3GPP Core Network and allows external parties to use the Exposure APIs offered by the network operator. The Network Exposure Function (NEF) supports the Exposure APIs.

The Unified Data Repository (UDR) stores subscription-related data such as Subscription Data, Policy Data, Structured Data for Exposure, and Application Data.

The Policy Control Function (PCF) supports a unified policy framework to govern the network behaviour. Specifically, the PCF provides PCC (Policy and Charging Control) rules to enforce policy and charging decisions according to provisioned PCC rules.

The Session Management function (SMF) receives PCC rules from the PCF and configures the User Plane function (UPF) accordingly.

The User Plane function (UPF) supports handling of user plane traffic based on the rules received from the SMF, e.g., packet inspection and different enforcement actions such as QoS handling.

The Network Function (NF) Repository Function (NRF) is the network entity in the 5G Core Network (5GC) that maintains the NF profile of available NF instances and their supported services and supports NF discovery.

Digital scent technology (or olfactory technology) is the engineering discipline dealing with olfactory representation in electronic or digital format. It is a technology that enables to sense, transmit and receive scent-enabled digital media (such as web pages, video games, movies and music). This sensing part of this technology works by using olfactometers and electronic noses.

The Tactile Internet refers to network solutions to enable haptic interaction with visual feedback. The term haptic relates to the sense of touch, in particular the perception and manipulation of objects using touch and proprioception. Proprioception is the sense of the relative positioning of the parts of one's body and the strength of effort used in movement.

Internet of Senses refers to technologies that leverage the interaction with various senses including smell, vision, taste, touch, and sound for human-machine interaction. Sense information and sense media (other than audio and video) are used by applications to convey sensorial experiences to the users.

A problematic aspect of the current solutions is that communication networks are adapted to transmit information based on visual (SMS, web, etc.) or sound (ring alerts, audio messages, etc.) information. In an Internet of Senses scenario, the terminal devices incorporate multiple sensors and emitters of sensorial information, including smell, touch, and taste. Current communications networks are not adapted to handle these sorts of devices in a proper manner, e.g., incoordination between the terminal devices, the communications network and the applications involving the usage of sensorial information could lead to delivering sensorial information to devices that do not support the proper sensors or emitters, Internet of Sense-enabled terminal devices could connect to networks not adapted to operate in an Internet of Senses scenario, or Internet of Sense applications could face connectivity issues when delivering sense information to the target Internet of Sense-enabled devices.

### SUMMARY

An object of the invention is to enable handling sensorial information in a communications network. Sensorial information is transmitted and received by an application and a user device that support sensing and emitting sensorial stimuli. The communications network handles the connection between the application and the user device, including the delivery of the sensorial information.

A first aspect of the invention relates to a method performed by a sense device manager for handling sensorial information in a communications network. The method comprises receiving at a sense device manager from an application node sensorial information, an action associated to the sensorial information, and an indication of a target user device for the sensorial information; and transmitting from the sense device manager to a user device the sensorial information and the action associated to the sensorial information. In some embodiments, the method further comprises receiving at the sense device manager from the user device capability information on at least one sensorial information supported by the user device; and transmitting from the sense device manager to the user device sensorial information based on the capability information transmitted by the user device. In some embodiments, the method further comprises transmitting from the sense device manager to the application node capability information on at least one sensorial information supported by the sense device manager; and receiving at the sense device manager from the application node sensorial information based on the capability information transmitted by the sense device manager. In some embodiments, the sensorial information includes at least one of a type of sense associated with the sensorial information and information defining sensorial stimuli associated with the sensorial information. In some embodiments, the action associated to the sensorial information indicates to emit or detect the sensorial stimuli defined by the sensorial information. In some embodiments, the action associated to the sensorial information indicates to transmit to the sense device manager or to the application node a message indicating the emission of the sensorial stimuli or the detection of the sensorial stimuli by the user device. In some embodiments, the action associated to the sensorial information indicates a policy action or rule to apply to the network traffic of the sensorial information. In some embodiments, the indication of the target user device comprises at least one of a user device identifier, a user device type, a location of the user device or an area of the user device. In some embodiments, the sense device manager transmits the sensorial information to at least one user device that supports the sensorial information, particularly wherein the user device is present in the location or the area indicated as part of the indication of the target user device. In some embodiments, the sense device manager transmits to the user device the sensorial information and the action associated to the sensorial information through an intermediary entity, wherein the intermediary entity is a control plane entity, a user plane entity, or an application entity. In some embodiments, the capability information on at least one sensorial information comprises information on whether the sensorial information is supported by emitting or detecting sensorial stimuli defined by the sensorial information. In some embodiments, the sense device manager is a network exposure node or is implemented in or collocated with the network exposure node. In some embodiments, the sense device manager is implemented as a web portal or a mobile application. In some embodiments, the sensorial information is smell information or tactile information. In some embodiments, the network exposure node is a Network Exposure Function (NEF), the user device is a User Equipment (UE), the control plane node is an Access and Mobility Management Function (AMF), the user plane node is a User Plane Function (UPF) and the application node is an Application Function (AF).

A second aspect of the invention relates to a method performed by a user device for handling sensorial information in a communications network. The method comprises receiving at a user device from a sense device manager a sensorial information and an action associated to the sensorial information; and initiating at the user device the action. In some embodiments, the method further comprises transmitting from the user device to the sense device manager capability information on at least one sensorial information supported by the user device; and receiving at the user device from the sense device manager sensorial information based on the capability information transmitted by the user device. In some embodiments, the sensorial information includes at least one of a type of sense associated with the sensorial information and information defining sensorial stimuli associated with the sensorial information. In some embodiments, the action associated to the sensorial information indicates to emit or detect the sensorial stimuli defined by the sensorial information. In some embodiments, the action associated to the sensorial information indicates to transmit to the sense device manager or to the application node a message indicating the emission of the sensorial stimuli or the detection of the sensorial stimuli by the user device. In some embodiments, the action associated to the sensorial information indicates a policy action or rule to apply to the network traffic of the sensorial information. In some embodiments, the capability information on at least one sensorial information comprises information on whether the sensorial information is supported by emitting or detecting sensorial stimuli defined by the sensorial information. In some embodiments, the sense device manager is a network exposure node or is implemented in or collocated with the network exposure node. In some embodiments, the sense device manager is implemented as a web portal or a mobile application. In some embodiments, the sensorial information is smell information or tactile information. In some embodiments, initiating the action at the user device comprises emitting or detecting the sensorial stimuli associated with the sensorial information. In some embodiments, the network exposure node is a Network Exposure Function (NEF), and the user device is a User Equipment (UE).

A third aspect of the invention relates to a method performed by an application node for handling sensorial information in a communications network. The method comprises transmitting from an application node to a sense device manager sensorial information, an action associated to the sensorial information, and an indication of a target user device for the sensorial information. In some embodiments, the method further comprises receiving at the application node from the sense device manager capability information on at least one sensorial information supported by the sense device manager; and transmitting from the application node to the sense device manager sensorial information based on the capability information transmitted by the sense device manager. In some embodiments, the sensorial information includes at least one of a type of sense associated with the sensorial information and information defining sensorial stimuli associated with the sensorial information. In some embodiments, the action associated to the sensorial information indicates to emit or detect the sensorial stimuli defined by the sensorial information. In some embodiments, the action associated to the sensorial information indicates to transmit to the sense device manager or to the application node a message indicating the emission of the sensorial stimuli or the detection of the sensorial stimuli by the user device. In some embodiments, the action associated to the sensorial information indicates a policy action or rule to apply to the network traffic of the sensorial information. In some embodiments, the indication of the target user device comprises at least one of a user device identifier, a user device type, a location of the user device or an area of the user device. In some embodiments, the capability information on at least one sensorial information comprises information on whether the sensorial information is supported by emitting or detecting sensorial stimuli defined by the sensorial information. In some embodiments, the sense device manager is a network exposure node or is implemented in or collocated with the network exposure node. In some embodiments, the sense device manager is implemented as a web portal or a mobile application. In some embodiments, the sensorial information is smell information or tactile information. In some embodiments, the network exposure node is a Network Exposure Function (NEF), the user device is a User Equipment (UE), the control plane node is an Access and Mobility Management Function (AMF), the user plane node is a User Plane Function (UPF) and the application node is an Application Function (AF).

Other aspects of the invention relate to mobile network nodes, particularly a user device (101, 1200), an application node (113, 1300), a sense device manager (109, 1100) configured to perform the respective methods as described herein. Other aspects of the invention relate to computer program and computer program products.

In some embodiments, the user device is a User Equipment (UE). In some embodiments, the application node is an Application Function (AF). In some embodiments, the sense device manager is a Sensorial Device Manager (SDM).

Advantageously, the solution disclosed herein enables to transmit sensorial information from an application to a user device that supports the proper capabilities to handle such sensorial information.

Further advantageously, the solution disclosed herein enables the communications network to enforce appropriate policy actions associated to the network traffic of the sensorial information.

Additional objectives, features and advantages of the concepts disclosed herein will be apparent from the following description, claims and drawings, or may be learned by practice of the described technologies and concepts as set forth herein.

### BRIEF DESCRIPTION OF THE DRAWINGS

In order to best describe the manner in which the disclosed concepts may be implemented, as well as define other objects, advantages and features of the disclosure, a more particular description is provided below and is illustrated in the appended drawings. Understanding that these drawings depict only exemplary embodiments of the invention and are not therefore to be considered to be limiting in scope, the examples will be described and explained with additional specificity and detail through the use of the accompanying drawings.

FIG. 1 illustrates an example networked system in accordance with particular embodiments of the solution described herein.

FIG. 2 illustrates an example signaling diagram showing a procedure according to particular embodiments of the solution described herein.

FIG. 3 illustrates an example signaling diagram showing a procedure according to particular embodiments of the solution described herein.

FIGS. 4A-4C illustrate an example signaling diagram showing a procedure according to particular embodiments of the solution described herein.

FIGS. 5A-5B illustrate an example signaling diagram showing a procedure according to particular embodiments of the solution described herein.

FIGS. 6A-6C illustrates an example signaling diagram showing a procedure according to particular embodiments of the solution described herein.

FIGS. 7A-7B illustrates an example signaling diagram showing a procedure according to particular embodiments of the solution described herein.

FIG. 8 illustrates an example flowchart showing a method performed by a mobile network node according to particular embodiments of the solution described herein.

FIG. 9 illustrates an example flowchart showing a method performed by a UE according to particular embodiments of the solution described herein.

FIG. 10 illustrates an example flowchart showing a method performed by a mobile network node according to particular embodiments of the solution described herein.

FIG. 11 illustrates an example block diagram of a mobile network node configured in accordance with particular embodiments of the solution described herein.

FIG. 12 illustrates an example block diagram of a UE configured in accordance with particular embodiments of the solution described herein.

FIG. 13 illustrates an example block diagram of a mobile network node configured in accordance with particular embodiments of the solution described herein.

### DETAILED DESCRIPTION

The invention will now be described in detail hereinafter with reference to the accompanying drawings, in which examples of embodiments or implementations of the invention are shown. The invention may, however, be embodied or implemented in many different forms and should not be construed as limited to the embodiments set forth herein. Rather, these embodiments are provided so that this disclosure will be thorough and complete, and will fully convey the scope of present invention to those skilled in the art. It should also be noted that these embodiments are not mutually exclusive. Components from one embodiment may be tacitly assumed to be present/used in another embodiment. These embodiments of the disclosed subject matter are presented as teaching examples and are not to be construed as limiting the scope of the disclosed subject matter. For example, certain details of the described embodiments may be modified, omitted, or expanded upon without departing from the scope of the described subject matter.

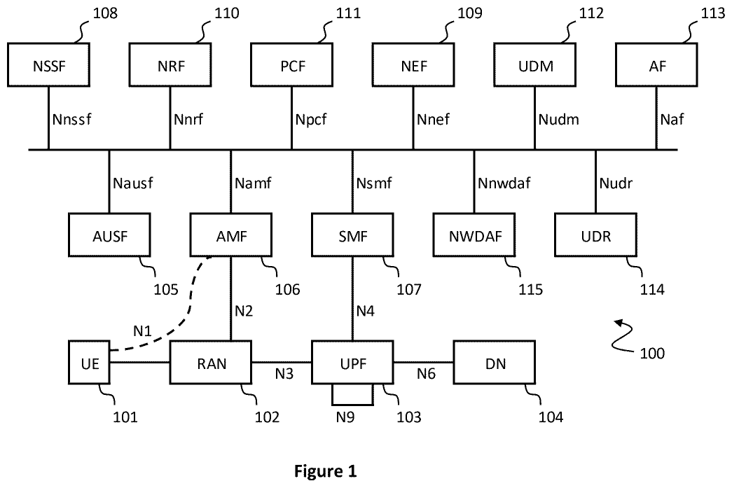

The example embodiments described herein arise in the context of a telecommunications network, including but not limited to a telecommunications network that conforms to and/or otherwise incorporates aspects of a fifth generation (5G) architecture. FIG. 1 is an example networked system 100 in accordance with example embodiments of the present disclosure. FIG. 1 specifically illustrates User Equipment (UE) 101, which may be in communication with a (Radio) Access Network (RAN) 102 and Access and Mobility Management Function (AMF) 106 and User Plane Function (UPF) 103. The AMF 106 may, in turn, be in communication with core network services including Session Management Function (SMF) 107 and Policy Control Function (PCF) 111. The core network services may also be in communication with an Application Server/Application Function (AS/AF) 113. Other networked services also include Network Slice Selection Function (NSSF) 108, Authentication Server Function (AUSF) 105, User Data Management (UDM) 112, Network Exposure Function (NEF) 109, Network Repository Function (NRF) 110, User Data Repository (UDR) 114, Network Data Analytics Function (NWDAF) 115, and Data Network (DN) 104. In some example implementations of embodiments of the present disclosure, each one of the entities in the networked system 100 are considered to be a Network Function (NF). One or more additional instances of the NFs may be incorporated into the networked system.

The solution described herein aims to enable handling sensorial information in a communications network. Sensorial information is transmitted and received by an application and a user device that support sensing and emitting sensorial stimuli. The communications network handles the connection between the application and the user device, including the delivery of the sensorial information. Sensorial information may be an electronic or binary representation of the sensorial stimuli.

This disclosure provides a method for handling sensorial information in a communications network. The method comprises transmitting from an application node to a sense device manager sensorial information, an action associated to the sensorial information, and an indication of a target user device for the sensorial information; transmitting from the sense device manager to a user device the sensorial information and the action associated to the sensorial information; and initiating at the user device the action. In some embodiments, the method further comprises transmitting from the user device to the sense device manager capability information on at least one sensorial information supported by the user device; and transmitting from the sense device manager to the user device sensorial information based on the capability information transmitted by the user device. In some embodiments, the method further comprises transmitting from the sense device manager to the application node capability information on at least one sensorial information supported by the sense device manager; and transmitting from the application node to the sense device manager sensorial information based on the capability information transmitted by the sense device manager. In some embodiments, the sensorial information includes at least one of a type of sense associated with the sensorial information and information defining sensorial stimuli associated with the sensorial information. In some embodiments, the action associated to the sensorial information indicates to emit or detect the sensorial stimuli defined by the sensorial information. In some embodiments, the action associated to the sensorial information indicates to transmit to the sense device manager or to the application node a message indicating the emission of the sensorial stimuli or the detection of the sensorial stimuli by the user device. In some embodiments, the action associated to the sensorial information indicates a policy action or rule to apply to the network traffic of the sensorial information. In some embodiments, the indication of the target user device comprises at least one of a user device identifier, a user device type, a location of the user device or an area of the user device. In some embodiments, the sense device manager transmits the sensorial information to at least one user device that supports the sensorial information, particularly wherein the user device is present in the location or the area indicated as part of the indication of the target user device. In some embodiments, the sense device manager transmits to the user device the sensorial information and the action associated to the sensorial information through an intermediary entity, wherein the intermediary entity is a control plane entity, a user plane entity, or an application entity. In some embodiments, the capability information on at least one sensorial information comprises information on whether the sensorial information is supported by emitting or detecting sensorial stimuli defined by the sensorial information. In some embodiments, the sense device manager is a network exposure node or is implemented in or collocated with the network exposure node. In some embodiments, the sense device manager is implemented as a web portal or a mobile application. In some embodiments, the sensorial information is smell information or tactile information. In some embodiments, initiating the action at the user device comprises emitting or detecting the sensorial stimuli associated with the sensorial information. In some embodiments, the network exposure node is a Network Exposure Function (NEF), the user device is a User Equipment (UE), the control plane node is an Access and Mobility Management Function (AMF), the user plane node is a User Plane Function (UPF) and the application node is an Application Function (AF).

This disclosure also provides mobile network nodes, particularly a user device (101, 1200), an application node (113, 1300), and a sense device manager (109, 1100) configured to perform the respective methods as described herein. In some embodiments, the user device is a User Equipment (UE) 101. In some embodiments, the application node is an Application Function (AF) 113. In some embodiments, the sense device manager is a Sense/Sensorial Device Manager (SDM). In some embodiments, the sense device manager is a Network Exposure Function (109).

This disclosure also provides the corresponding computer program and computer program products comprising code, for example in the form of a computer program, that when run on processing circuitry of the mobile network nodes causes the mobile network nodes to perform the disclosed methods.

Advantageously, the solution disclosed herein enables to transmit sensorial information from an application to a user device that supports the proper capabilities to handle such sensorial information.

Further advantageously, the solution disclosed herein enables the communications network to enforce appropriate policy actions associated to the network traffic of the sensorial information.

Hereinafter, drawings showing examples of embodiments of the solution are described in detail.

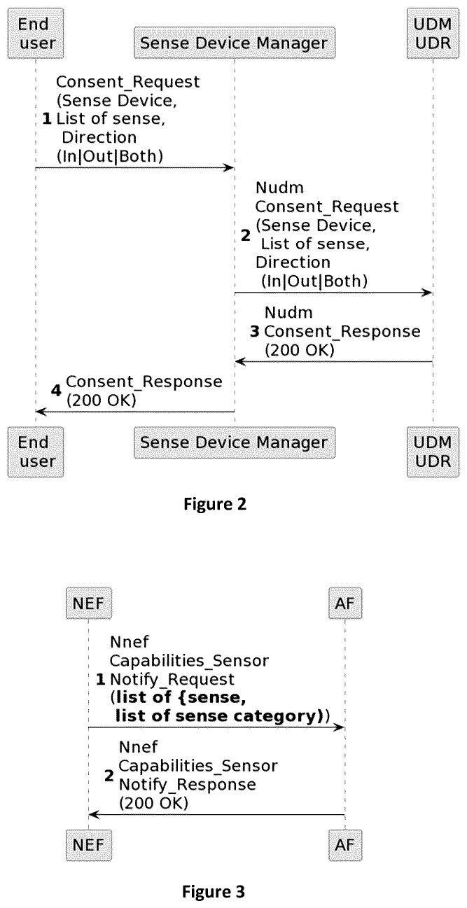

FIG. 2 is a signaling diagram illustrating a procedure for handling sensorial information in a communications network. The procedure is performed by an end user/user device (101, 1200), a sense device manager (109, 1100) and a UDM/UDR 112 configured to perform the respective methods as described herein. In some embodiments, the user device is a User Equipment (UE) 101. In some embodiments, the sense device manager is a Sense/Sensorial Device Manager (SDM). In some embodiments, the sense device manager is a Network Exposure Function (109).
Step 1) The end user (user device) provides to the Sense Device Manager the sensors that it supports and can be discovered externally. The end user provides a list of sensors with the following information:
   Device identifier
   list of senses that can be handled by the device (e.g., smell or tactile)
   sensorial information direction:
      uplink—indicates that the device sends sensorial information traffic from end user to external applications (i.e., the device detects the sensorial stimuli by means of sensors), and/or
      downlink—indicates that the device receives sensorial information traffic from external applications (i.e., the device emits the sensorial stimuli by means of emitters)
Step 2) The Sense Device Manager (SDM) sends the previous information to UDR. The Sense Device Manager is a node that can act as an application operator portal where end users can get, modify, or provide information about contracts that they have or sensors that they have. The Sense Device Manager is the place where end user using her/his credentials logs in and see all products and things contracted with operator. In this case, end user provides permission to exposed externally sensors that belongs to this device.

The Sense Device Manager can be a separate function or collocated with the NEF.
Step 3) The UDR confirms the request of step 2.
Step 4) The Sense Device Manager confirms the request of step 1.

FIG. 3 is a signaling diagram illustrating a procedure for handling sensorial information in a communications network. The procedure is performed by an application node (113, 1300), and a sense device manager (109, 1100) configured to perform the respective methods as described herein. In some embodiments, the application node is an Application Function (AF) 113. In some embodiments, the sense device manager is a Sense/Sensorial Device Manager (SDM). In some embodiments, the sense device manager is a Network Exposure Function (NEF) 109.

This figure shows how the network exposes (via NEF) that it handles sensorial information. E.g., that it can send notification or receive notifications including sensorial information.
Step 1) The NEF exposes to the AF the supported sensorial capabilities, e.g., which senses can be notified and with which type of sense. The message includes:
   Type of Sense—e.g., smell, tactile.
   Sense Category:
      for smell: e.g., description of smell information
      for tactile: e.g., description of tactile information
Step 2) AF confirms the capabilities received in the previous step.

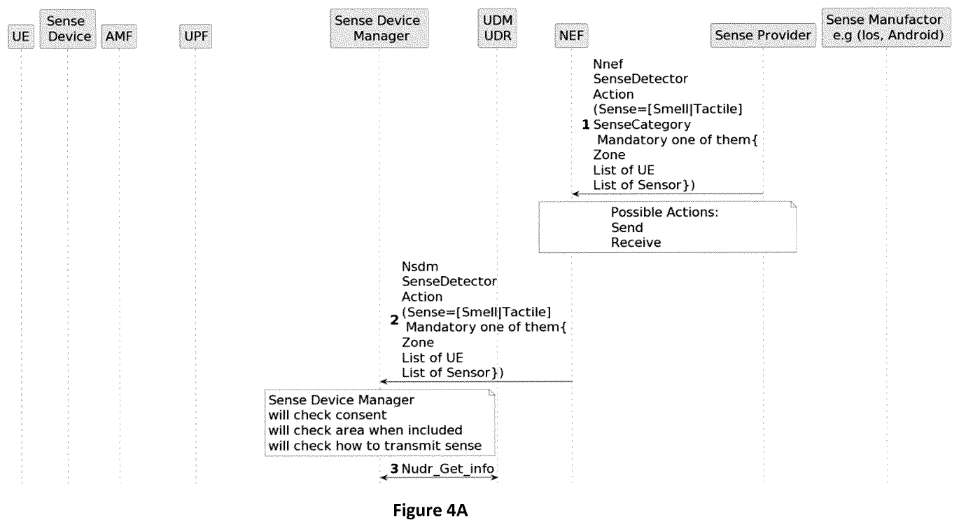

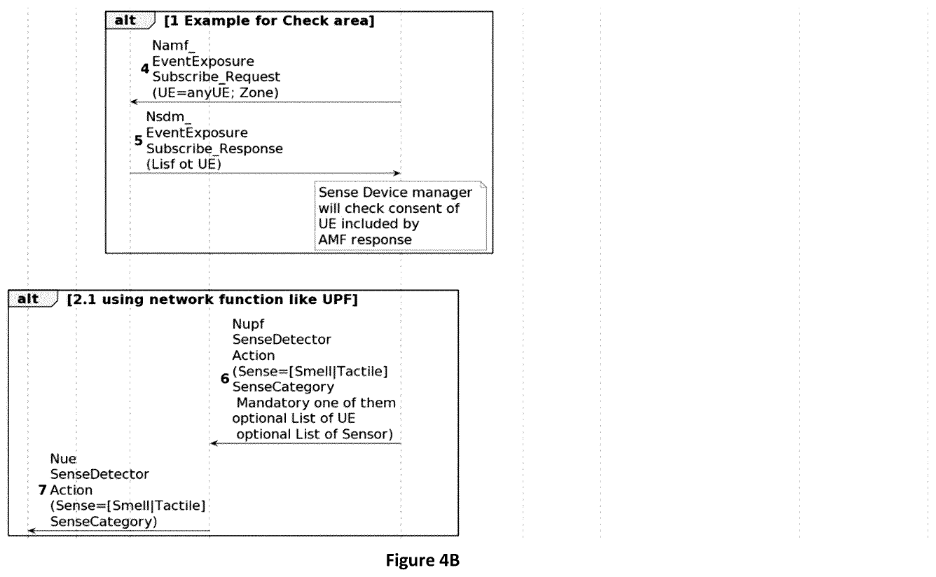

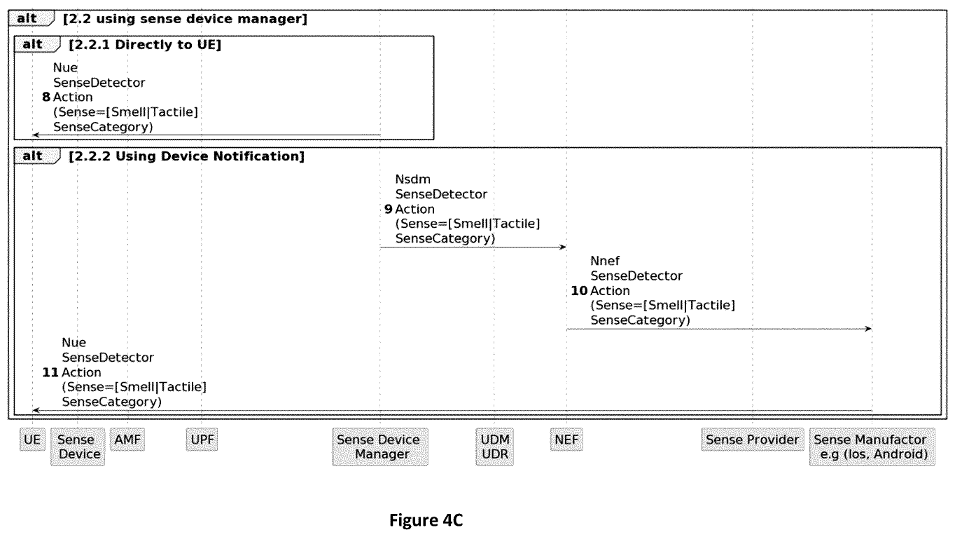

FIGS. 4A-4C show a signaling diagram illustrating a procedure for handling sensorial information in a communications network. The procedure is performed by a user device/sense device (101, 1200), an application node (113, 1300), a UDM/UDR 112, a UPF 103, an AMF 105, and a sense device manager (109, 1100) configured to perform the respective methods as described herein. In some embodiments, the user device is a User Equipment (UE) 101. In some embodiments, the application node is an Application Function (AF) 113 of a Sense Provider. In some embodiments, the application node is an Application Function (AF) 113 of a Sense Manufacturer. In some embodiments, the sense device manager is a Sense/Sensorial Device Manager (SDM). In some embodiments, the sense device manager is a Network Exposure Function (109).
Step 1) The Sense Provider (AF) sends a request to NEF. The request includes:
   Sensorial information:
      Sense: type of sense, e.g., smell or tactile
      Sense Category: depends on the type of sense. For example,
         for smell: e.g., description of smell information
         for tactile: e.g., description of tactile information
   Zone: area where the send or receive action applies
   List of UE: list of UEs that are affected by the send or receive action
   List of Sensors: list of sensors that are affected by the send or receive action
   Action—action to be executed for the traffic of the sensorial information. It can be e.g.,
      Send or Receive indication:
         Send—indicates that the Sense Provider sends sensorial information traffic towards the end user (user device)
         Receive—indicates that the Sense Provider receives traffic from the end user (user device)
      Sense/detect or Emit indication:
         Sense/detect—indicates that the end user (user device) senses or detects sensorial stimuli defined by the sensorial information provided by the Sense Provider.
         Emit—indicates that the end user (user device) emits sensorial stimuli defined by the sensorial information provided by the Sense Provider.
      Policy action—policy rule to enforce for the traffic of the sensorial information, e.g., QoS enforcement, reporting actions, etc.

In this disclosure, the action and the send or receive indication are used indistinctively.
Step 2) The NEF sends to the Sense Device Manager the information in the previous request.
Step 3) The Sense Device Manager will check the authorization or consent of the different sensors with UDR. It also will check if the action is valid. The Sense Device Manager notifies back to NEF if the UEs or sensors are not allowed by end user or if the action is not valid.
Steps 4-5 take place when the Sense Provider includes the area or zone in which their request should be applied.
Step 4) The Sense Device Manager or via NEF (sending corresponding request) gets the list of UE according to the area.
Step 5) The AMF sends the list of UE that belongs to the area. Then the Sense Device Manager will perform step 3 again with the list sent by the AMF.

The Sense Device Manager may notify the action to the end user.
Step 6) The Sense Device Manager sends this request to the UPF. The UPF will get the sensorial information and sense category from a repository (not depicted in the figure) and sends it to the UE.

The Sense Device Manager knows which UPF corresponds with each user checking with the SMF. The SMF can provide the list of UPFs for each UE.
Step 7) The UPF sends to the UE the corresponding sense information and sense category. This step may be a notification using the Sense Device Manager or direct communication towards the UE.
Step 8) The Sense Device Manager can interact directly with the end user, so it sends the corresponding action, sense information, and sense category to the UE.

This step may be a notification using the Sense Device Manager and/or via the operating system of the UE/sensor.
Step 9) The Sense Device Manager sends the request of the corresponding action, sense information, and sense category to the NEF.
Step 10) The NEF sends the previous information to the Sense manufacturer, i.e., the owner of the sensorial information, which usually has a notification platform towards the end user or the user device.
Step 11) The sense manufacturer sends the previous information in a notification to the end user.

A notification is a message that the Operating System displays outside the device user interface to provide the user with reminders, communication from other people, or other timely information from your app. Users can tap the notification to open or take an action directly from the notification.

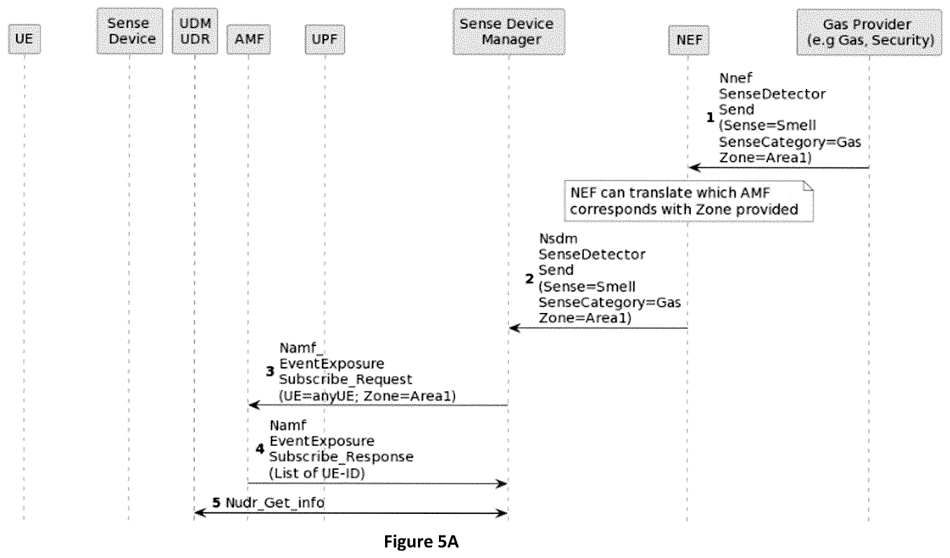

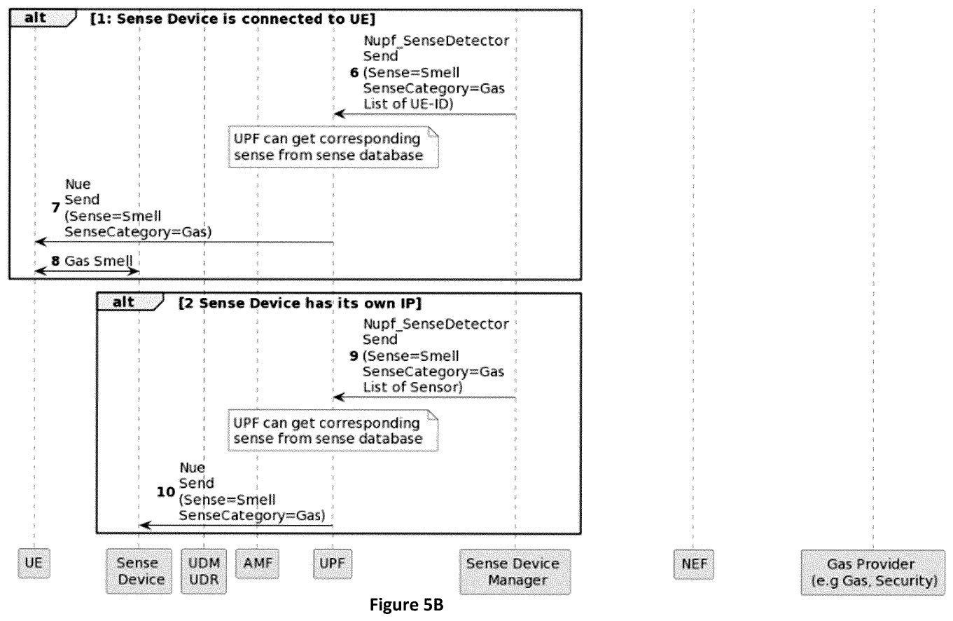

FIGS. 5A-5B show a signaling diagram illustrating a procedure for handling sensorial information in a communications network. The procedure is performed by a user device/sense device (101, 1200), an application node (113, 1300), a UDM/UDR 112, a UPF 103, an AMF 105, and a sense device manager (109, 1100) configured to perform the respective methods as described herein. In some embodiments, the user device is a User Equipment (UE) 101. In some embodiments, the application node is an Application Function (AF) 113 of a Gas Sense Provider. In some embodiments, the sense device manager is a Sense/Sensorial Device Manager (SDM). In some embodiments, the sense device manager is a Network Exposure Function (109).

This figure shows an embodiment where a gas company wants to inform end users using internet of sense about a gas leakage.
Step 1) The AF detects a gas leakage in a specific zone, and they want to inform using Internet of Sense about this gas leakage to their users. The AF sends a Sense Notification to sensors of a specific zone. AF knows in advance that the network can notify via Internet of Sense.
Step 2) The NEF sends the previous information to the Sense Device Manager. The Sense Device Manager or NEF can identity zone defined by AF or AF can provide the corresponding zone to NEF. Sense Device Manager sends to AMF a request for knowing which UE belongs to the corresponding zone.
Step 3) The AMF responds with the list of UE that belongs to the zone.
Step 4) The Sense Device Manager gets the list of sensors associated with those UE-ID.
Step 5) The Sense Device Manager checks towards UDR permissions and direction of sensors. It gets the UE-ID or Sensors information from UDR
Step 6) The Sense Device Manager sends to the UPF that UPF needs to send Gas smell to the list of UE. Methane is tasteless, colorless, and odorless so suppliers intentionally add the smell, that is, they odorize natural gas with different chemical compounds as an olfactory alert so that it is easily detectable. These chemical compounds, such as methyl mercaptan, contain sulfur in their composition which gives it that characteristic smell.
Step 7) The UPF can get the corresponding gas smell from an internal database or an external database. Then UPF sends this smell to the corresponding UEs.
Step 8) UE sends the gas smell information to the attached sensors
Step 9) The Sense Device Manager sends to the UPF that UPF needs to send Gas smell to list of sensors. Methane is tasteless, colorless, and odorless so suppliers intentionally add the smell, that is, they odorize natural gas with different chemical compounds as an olfactory alert so that it is easily detectable. These chemical compounds, such as methyl mercaptan, contain sulfur in their composition which gives it that characteristic smell.
Step 10) The UPF can get the corresponding gas smell from an internal database or an external database. Then UPF sends this smell to the corresponding sensors.

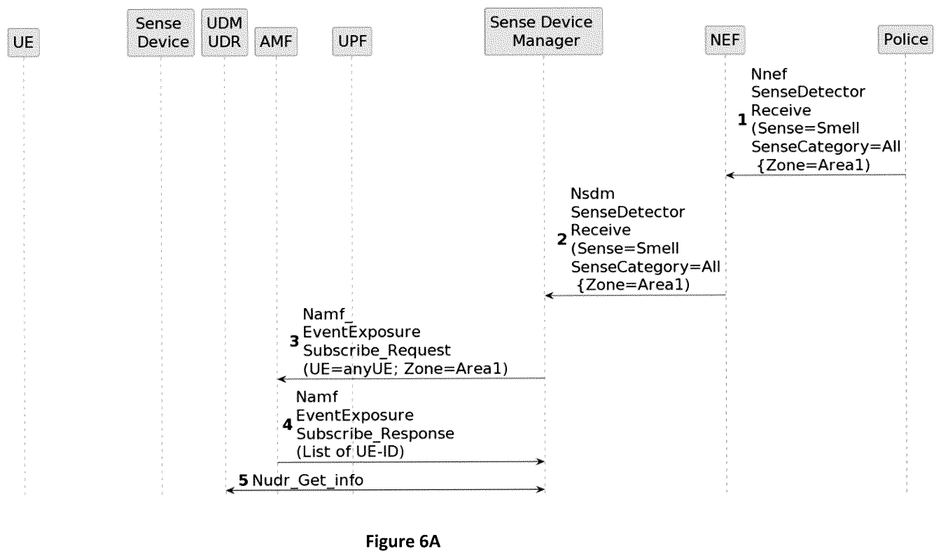

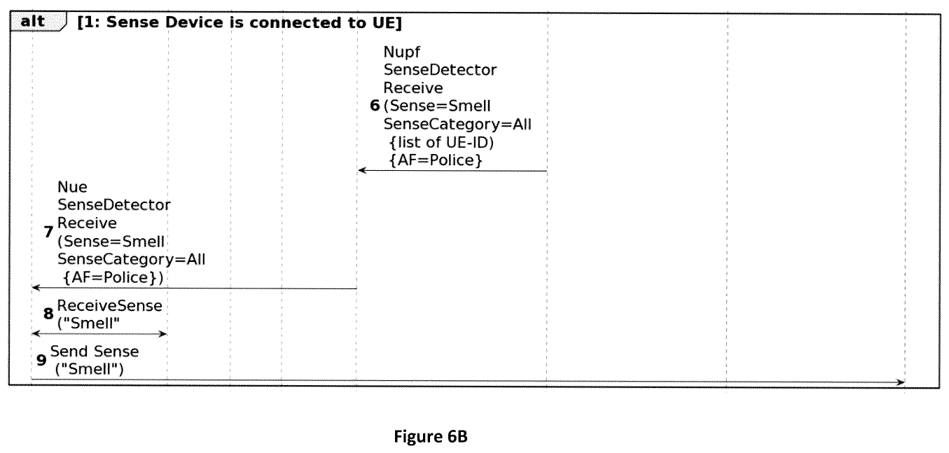

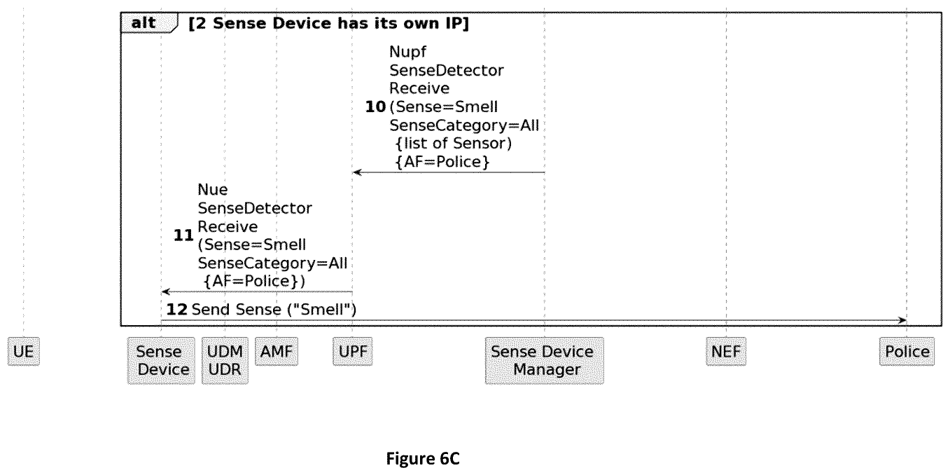

FIGS. 6A-6C show a signaling diagram illustrating a procedure for handling sensorial information in a communications network. The procedure is performed by a user device/sense device (101, 1200), an application node (113, 1300), a UDM/UDR 112, a UPF 103, an AMF 105, and a sense device manager (109, 1100) configured to perform the respective methods as described herein. In some embodiments, the user device is a User Equipment (UE) 101. In some embodiments, the application node is an Application Function (AF) 113 of a police application. In some embodiments, the sense device manager is a Sense/Sensorial Device Manager (SDM). In some embodiments, the sense device manager is a Network Exposure Function (109).

This figure shows a use case where police want to get smell information about one zone using sensors that are in this area.
Step 1) The police want to detect smell in a specific zone, and they want to get smell using Internet of Sense. The AF using gets a Sense Notification from sensors in a specific zone.

The AF knows in advance that network can notify via Internet of Sense. In this case, Sense Category is defined as “all” because police department wants to get smell in the area. Also, as they can request a specific smell like for example nitroglycerine.
Step 2) The NEF sends the previous request to the Sense Device Manager. The NEF or Sense Device Manager identify the zone defined by the AF or the AF provides the corresponding zone to the NEF. NEF or Sense Device Manager sends to AMF a request for the UEs that are in the corresponding zone
Step 3) The AMF responds with the list of UE-IDs that are in the zone.
Step 4) The Sense Device Manager gets the list of sensors associated with the received UE-IDs
Step 5) The Sense Device Manager checks with the UDR the authorization and action validity for the sensors. It gets UE-ID or Sensors from the UDR.
Step 6) The Sense Device Manager sends to the UPF which UE should send smell to the police. It may also include the requesting AF.
Step 7) The UPF sends the previous request to the corresponding UEs.
Step 8) The UE sends the previous request to the corresponding sensors.
Step 9) The UE sends to the police the smell detected by the sensor. The police may identify if there is any dangerous smell in the zone, like an explosive.
Step 10) The Sense Device Manager sends to the UPF which sensors should send smell to the police. It may also include the requesting AF.
Step 11) The UPF sends the previous request to the corresponding sensors.
Step 12) The sensor sends to police the smell detected.

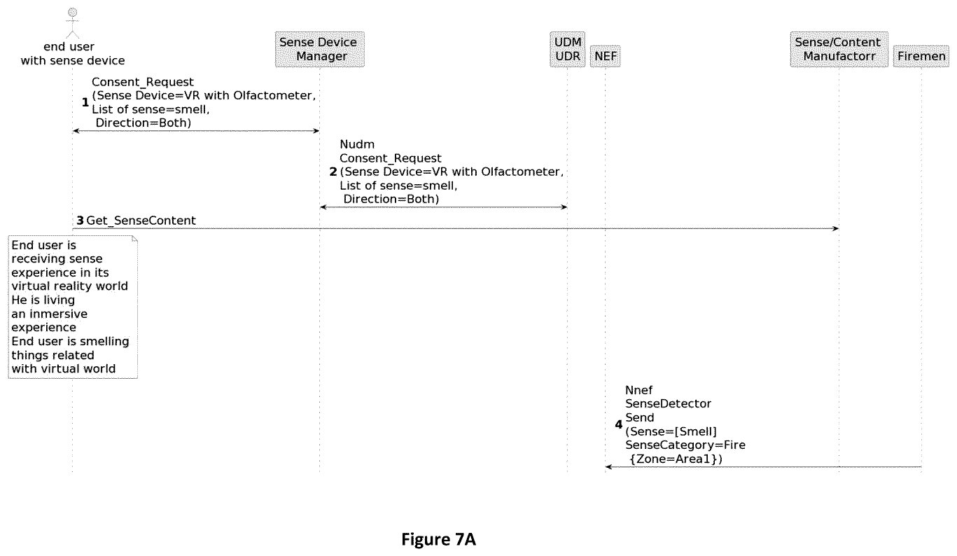

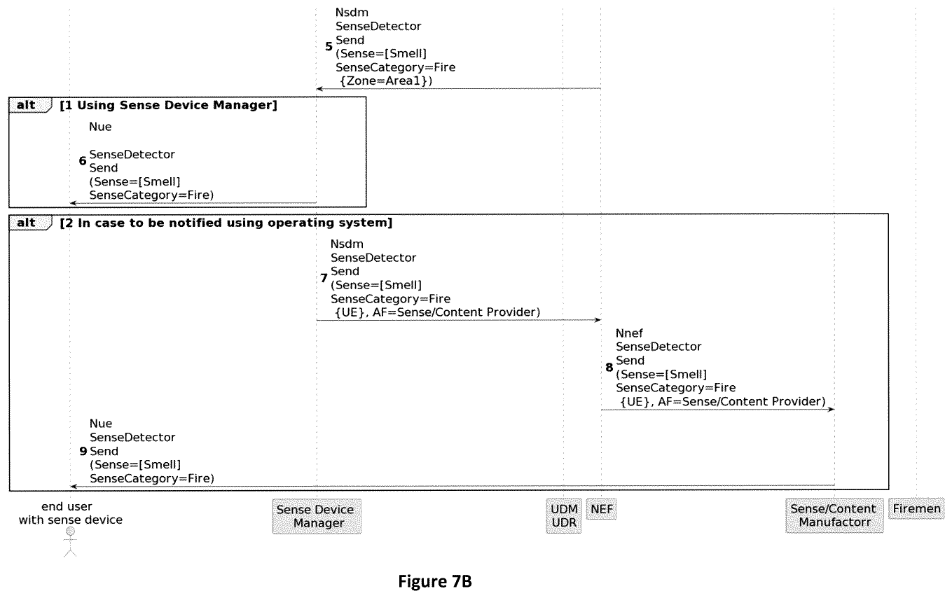

FIGS. 7A-7B show a signaling diagram illustrating a procedure for handling sensorial information in a communications network. The procedure is performed by a user device/sense device (101, 1200), an application node (113, 1300), a UDM/UDR 112, a UPF 103, an AMF 105, and a sense device manager (109, 1100) configured to perform the respective methods as described herein. In some embodiments, the user device is a User Equipment (UE) 101. In some embodiments, the application node is an Application Function (AF) 113 of a Sense/Content Provider or Manufacturer. In some embodiments, the application node is an Application Function (AF) 113 of a public service department (e.g., firemen). In some embodiments, the sense device manager is a Sense/Sensorial Device Manager (SDM). In some embodiments, the sense device manager is a Network Exposure Function (109).

This figure shows a use case where an end user is using an application of virtual reality or using a metaverse application that implies an immersive reality. The end user may have different sense experience according to the virtual world where they are immersed. Imagine for example, that they are playing in a game located in the beach where you can smell sea.
Step 1-2) Same steps as those described in FIG. 2, simplified in this diagram. In these steps end user has a device that allows to have immersive experience with smell included.
Step 3) End user is enjoying with this experience towards their content provider.
Step 4) The police or firemen department wants to send an alert of smell in a particular area. The end user is completely immersed in their virtual reality so this type of notification should have more priority than its virtual experience.
Step 5) NEF sends the previous request to the Sense Device Manager.
Step 6) If the Sense Device Manager has direct communication to the end user for sending notification, it sends the fire smell to the end user.
Step 7) Other alternative is that the Sense Device Manager sends to NEF a notification to be sent to the software manufacturer of the VR with olfactometer.
Step 8) The NEF sends this request to the manufacturer.
Step 9) The manufacturer sends the previous request to the end user. The end user receives the fire smell in his device interrupting their immersive experience.

Hereinafter, flowcharts showing examples of embodiments of the solution are described in detail.

“The embodiments correspond to methods performed by and involving a user device (101, 1200), an application node (113, 1300), a sense device manager (109, 1100).

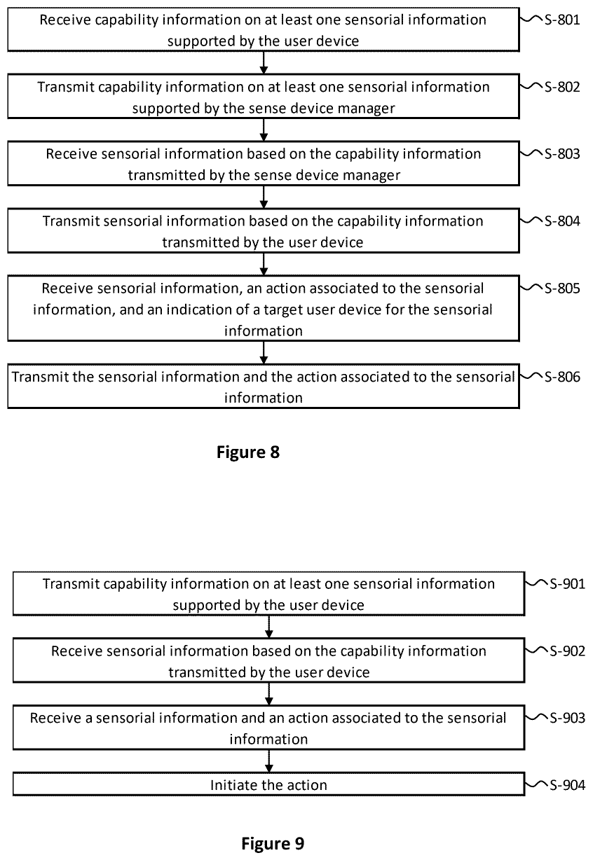

FIG. 8 is a flowchart illustrating a method performed by the sense device manager for handling sensorial information in a communications network.
In step S-801, the sense device manager receives from the user device capability information on at least one sensorial information supported by the user device.
In step S-802, the sense device manager transmits to the application node capability information on at least one sensorial information supported by the sense device manager.
In step S-803, the sense device manager receives from the application node sensorial information based on the capability information transmitted by the sense device manager.
In step S-804, the sense device manager transmits to the user device sensorial information based on the capability information transmitted by the user device.
In step S-805, the sense device manager receives from an application node sensorial information, an action associated to the sensorial information, and an indication of a target user device for the sensorial information.
In step S-806, the sense device manager transmits to a user device the sensorial information and the action associated to the sensorial information.

In some embodiments, the sensorial information includes at least one of a type of sense associated with the sensorial information and information defining sensorial stimuli associated with the sensorial information.

In some embodiments, the action associated to the sensorial information indicates to emit or detect the sensorial stimuli defined by the sensorial information.

In some embodiments, the action associated to the sensorial information indicates to transmit to the sense device manager or to the application node a message indicating the emission of the sensorial stimuli or the detection of the sensorial stimuli by the user device.

In some embodiments, the action associated to the sensorial information indicates a policy action or rule to apply to the network traffic of the sensorial information.

In some embodiments, the indication of the target user device comprises at least one of a user device identifier, a user device type, a location of the user device or an area of the user device.

In some embodiments, the sense device manager transmits the sensorial information to at least one user device that supports the sensorial information, particularly wherein the user device is present in the location or the area indicated as part of the indication of the target user device.

In some embodiments, the sense device manager transmits to the user device the sensorial information and the action associated to the sensorial information through an intermediary entity, wherein the intermediary entity is a control plane entity, a user plane entity, or an application entity.

In some embodiments, the capability information on at least one sensorial information comprises information on whether the sensorial information is supported by emitting or detecting sensorial stimuli defined by the sensorial information.

In some embodiments, the sense device manager is a network exposure node or is implemented in or collocated with the network exposure node.

In some embodiments, the sense device manager is implemented as a web portal or a mobile application.

In some embodiments, the sensorial information is smell information or tactile information.

In some embodiments, the network exposure node is a Network Exposure Function (NEF), the user device is a User Equipment (UE), the control plane node is an Access and Mobility Management Function (AMF), the user plane node is a User Plane Function (UPF) and the application node is an Application Function (AF).

FIG. 9 is a flowchart illustrating a method performed by the user device for handling sensorial information in a communications network.
In step S-901, the user device transmits to the sense device manager capability information on at least one sensorial information supported by the user device.
In step S-902, the user device receives from the sense device manager sensorial information based on the capability information transmitted by the user device.
In step S-903, the user device receives from a sense device manager a sensorial information and an action associated to the sensorial information.
In step S-904, the user device initiates the action.

In some embodiments, the sensorial information includes at least one of a type of sense associated with the sensorial information and information defining sensorial stimuli associated with the sensorial information.

In some embodiments, the action associated to the sensorial information indicates to emit or detect the sensorial stimuli defined by the sensorial information.

In some embodiments, the action associated to the sensorial information indicates to transmit to the sense device manager or to the application node a message indicating the emission of the sensorial stimuli or the detection of the sensorial stimuli by the user device.

In some embodiments, the action associated to the sensorial information indicates a policy action or rule to apply to the network traffic of the sensorial information.

In some embodiments, the capability information on at least one sensorial information comprises information on whether the sensorial information is supported by emitting or detecting sensorial stimuli defined by the sensorial information.

In some embodiments, the sense device manager is a network exposure node or is implemented in or collocated with the network exposure node.

In some embodiments, the sense device manager is implemented as a web portal or a mobile application.

In some embodiments, the sensorial information is smell information or tactile information.

In some embodiments, initiating the action at the user device comprises emitting or detecting the sensorial stimuli associated with the sensorial information.

In some embodiments, the network exposure node is a Network Exposure Function (NEF), and the user device is a User Equipment (UE).

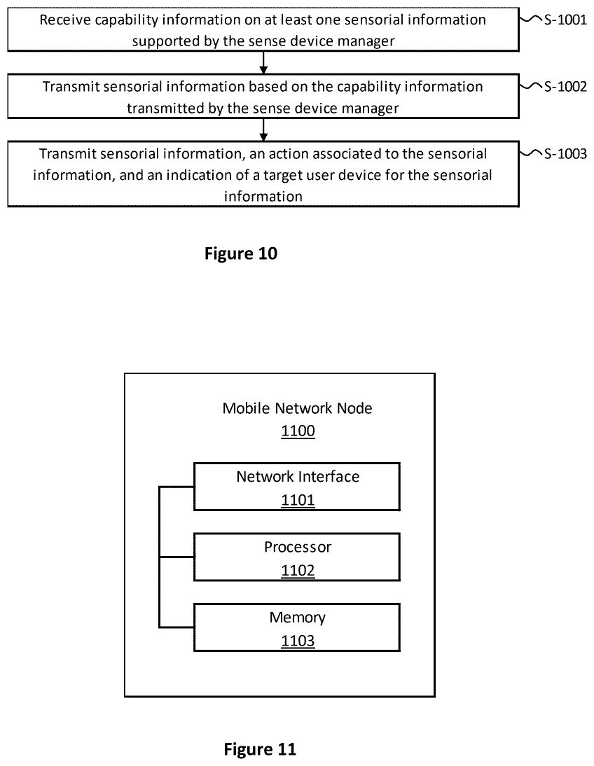

FIG. 10 is a flowchart illustrating a method performed by the application node for handling sensorial information in a communications network.
In step S-1001, the application node receives from the sense device manager capability information on at least one sensorial information supported by the sense device manager.
In step S-1002, the application node transmits to the sense device manager sensorial information based on the capability information transmitted by the sense device manager.
In step S-1003, the application node transmits to a sense device manager sensorial information, an action associated to the sensorial information, and an indication of a target user device for the sensorial information.

In some embodiments, the sensorial information includes at least one of a type of sense associated with the sensorial information and information defining sensorial stimuli associated with the sensorial information.

In some embodiments, the action associated to the sensorial information indicates to emit or detect the sensorial stimuli defined by the sensorial information.

In some embodiments, the action associated to the sensorial information indicates to transmit to the sense device manager or to the application node a message indicating the emission of the sensorial stimuli or the detection of the sensorial stimuli by the user device.

In some embodiments, the action associated to the sensorial information indicates a policy action or rule to apply to the network traffic of the sensorial information.

In some embodiments, the indication of the target user device comprises at least one of a user device identifier, a user device type, a location of the user device or an area of the user device.

In some embodiments, the capability information on at least one sensorial information comprises information on whether the sensorial information is supported by emitting or detecting sensorial stimuli defined by the sensorial information.

In some embodiments, the sense device manager is a network exposure node or is implemented in or collocated with the network exposure node.

In some embodiments, the sense device manager is implemented as a web portal or a mobile application.

In some embodiments, the sensorial information is smell information or tactile information.

In some embodiments, the network exposure node is a Network Exposure Function (NEF), the user device is a User Equipment (UE), the control plane node is an Access and Mobility Management Function (AMF), the user plane node is a User Plane Function (UPF) and the application node is an Application Function (AF).

FIG. 11 is a block diagram illustrating elements of a mobile network node 1100 of a mobile communications network. In some embodiments, the mobile network node 1100 is a NEF 109. As shown, the mobile network node may include network interface circuitry 1101 (also referred to as a network interface) configured to provide communications with other nodes of the core network and/or the network. The mobile network node may also include a processing circuitry 1102 (also referred to as a processor) coupled to the network interface circuitry, and memory circuitry 1103 (also referred to as memory) coupled to the processing circuitry. The memory circuitry 1103 may include computer readable program code that when executed by the processing circuitry 1102 causes the processing circuitry to perform operations according to embodiments disclosed herein. According to other embodiments, processing circuitry 1102 may be defined to include memory so that a separate memory circuitry is not required. As discussed herein, operations of the mobile network node may be performed by processing circuitry 1102 and/or network interface circuitry 1101. For example, processing circuitry 1102 may control network interface circuitry 1101 to transmit communications through network interface circuitry 1101 to one or more other network nodes and/or to receive communications through network interface circuitry from one or more other network nodes. Moreover, modules may be stored in memory 1103, and these modules may provide instructions so that when instructions of a module are executed by processing circuitry 1102, processing circuitry 1102 performs respective operations (e.g., operations discussed below with respect to Example Embodiments relating to core network nodes).

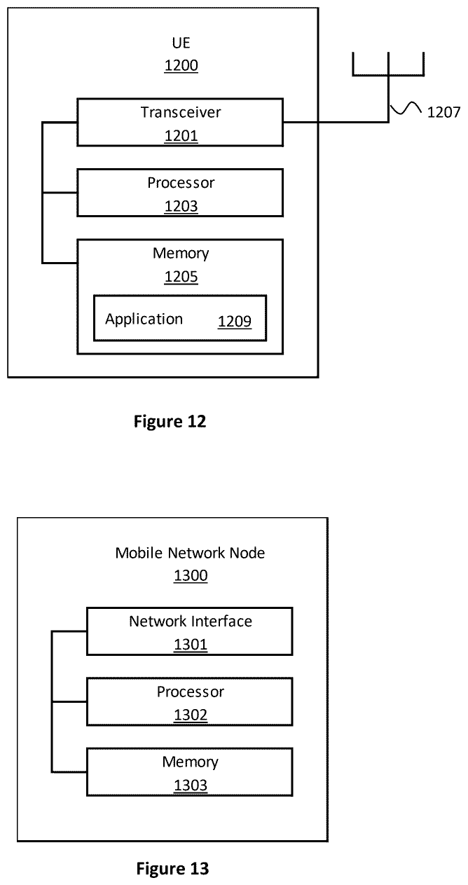

FIG. 12 is a block diagram illustrating elements of a User Equipment (UE) 1200 (also referred to as a communication device, a mobile terminal, a mobile communication terminal, a wireless device, a wireless communication device, a wireless terminal, mobile device, a wireless communication terminal, a user equipment node/terminal/device, etc.) configured to provide wireless communication according to embodiments of the disclosure. As shown, communication device UE may include an antenna 1207, and transceiver circuitry 1201 (also referred to as a transceiver) including a transmitter and a receiver configured to provide uplink and downlink radio communications with a base station(s) (also referred to as a RAN node) of a radio access network. The UE may also include processing circuitry 1203 (also referred to as a processor) coupled to the transceiver circuitry, and memory circuitry 1205 (also referred to as memory, e.g., corresponding to device readable medium) coupled to the processing circuitry. The memory circuitry 1205 may include computer readable program code, such as application client 1209, that when executed by the processing circuitry 1203 causes the processing circuitry to perform operations according to embodiments disclosed herein. According to other embodiments, processing circuitry 1203 may be defined to include memory so that separate memory circuitry is not required. The UE 1200 may also include an interface (such as a user interface) coupled with processing circuitry 1203, and/or the UE may be incorporated in a vehicle. As discussed herein, operations of the UE may be performed by processing circuitry 1203 and/or transceiver circuitry 1201. For example, processing circuitry 1203 may control transceiver circuitry 1201 to transmit communications through transceiver circuitry 1201 over a radio interface to a radio access network node (also referred to as a base station) and/or to receive communications through transceiver circuitry 1201 from a RAN node over a radio interface. Moreover, modules may be stored in memory circuitry 1205, and these modules may provide instructions so that when instructions of a module are executed by processing circuitry 1203, processing circuitry 1203 performs respective operations (e.g., the operations disclosed herein with respect to the example embodiments relating to the UE).

FIG. 13 is a block diagram illustrating elements of a mobile network node 1300 of a mobile communications network. In some embodiments, the mobile network node 1300 is an AF 113. As shown, the mobile network node may include network interface circuitry 1301 (also referred to as a network interface) configured to provide communications with other nodes of the core network and/or the network. The mobile network node may also include a processing circuitry 1302 (also referred to as a processor) coupled to the network interface circuitry, and memory circuitry 1303 (also referred to as memory) coupled to the processing circuitry. The memory circuitry 1303 may include computer readable program code that when executed by the processing circuitry 1302 causes the processing circuitry to perform operations according to embodiments disclosed herein. According to other embodiments, processing circuitry 1302 may be defined to include memory so that a separate memory circuitry is not required. As discussed herein, operations of the mobile network node may be performed by processing circuitry 1302 and/or network interface circuitry 1301. For example, processing circuitry 1302 may control network interface circuitry 1301 to transmit communications through network interface circuitry 1301 to one or more other network nodes and/or to receive communications through network interface circuitry from one or more other network nodes. Moreover, modules may be stored in memory 1303, and these modules may provide instructions so that when instructions of a module are executed by processing circuitry 1302, processing circuitry 1302 performs respective operations (e.g., operations discussed below with respect to Example Embodiments relating to core network nodes).

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such tangible computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the tangible computer-readable media.

Computer-executable instructions include, for example, instructions and data which cause a general purpose computer, special purpose computer, or special purpose processing device to perform a certain function or group of functions. Computer-executable instructions also include program modules that are executed by computers in standalone or network environments. Generally, program modules include routines, programs, objects, components, and data structures that perform particular tasks or implement particular abstract data types. Computer executable instructions, associated data structures, and program modules represent examples of the program code means for executing steps of the methods disclosed herein. The particular sequence of such executable instructions or associated data structures represent examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Communication at various stages of the described system can be performed through a local area network, a token ring network, the Internet, a corporate intranet, 802.11 series wireless signals, fiber-optic network, radio or microwave transmission, etc. Although the underlying communication technology may change, the fundamental principles described herein are still applicable.

The various embodiments described above are provided by way of illustration only and should not be construed to limit the invention. For example, the principles herein may be applied to any remotely controlled device. Further, those of skill in the art will recognize that communication between the remote the remotely controlled device need not be limited to communication over a local area network but can include communication over infrared channels, Bluetooth or any other suitable communication interface. Those skilled in the art will readily recognize various modifications and changes that may be made to the present invention without following the example embodiments and applications illustrated and described herein, and without departing from the scope of the present disclosure.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and “comprising,” when used in this specification, specify the presence of stated features, integers, steps, operations, elements, or components, and combinations thereof, but do not preclude the presence or addition of one or more other features, integers, steps, operations, elements, or components, and combinations thereof. Further, all terms used in the claims are to be interpreted according to their ordinary meaning in the technical field, unless explicitly defined otherwise herein. All references to ““a/an/the element, apparatus, component, means, module, step, etc.”” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

1. A method for handling sensorial information in a communications network, the method comprising:
transmitting from an application node to a sense device manager sensorial information, an action associated to the sensorial information, and an indication of a target user device for the sensorial information;
transmitting from the sense device manager to a user device the sensorial information and the action associated to the sensorial information; and
initiating at the user device the action.

2. The method of claim 1, further comprising:
transmitting from the user device to the sense device manager capability information on at least one sensorial information supported by the user device; and
transmitting from the sense device manager to the user device sensorial information based on the capability information transmitted by the user device.

3. The method of claim 1, further comprising:
transmitting from the sense device manager to the application node capability information on at least one sensorial information supported by the sense device manager; and
transmitting from the application node to the sense device manager sensorial information based on the capability information transmitted by the sense device manager.

4. The method of claim 1, wherein the sensorial information includes at least one of a type of sense associated with the sensorial information and information defining sensorial stimuli associated with the sensorial information.

5. The method of claim 1, wherein the action associated to the sensorial information indicates to emit or detect the sensorial stimuli defined by the sensorial information.

6. The method of claim 1, wherein the action associated to the sensorial information indicates to transmit to the sense device manager or to the application node a message indicating the emission of the sensorial stimuli or the detection of the sensorial stimuli by the user device.

7. The method of claim 1, wherein the action associated to the sensorial information indicates a policy action or rule to apply to the network traffic of the sensorial information.

8. The method of any claim 1, wherein the indication of the target user device comprises at least one of a user device identifier, a user device type, a location of the user device or an area of the user device.

9. The method of claim 8, wherein the sense device manager transmits the sensorial information to at least one user device that supports the sensorial information, particularly wherein the user device is present in the location or the area indicated as part of the indication of the target user device.

10. The method of claim 1, wherein the sense device manager transmits to the user device the sensorial information and the action associated to the sensorial information through an intermediary entity, wherein the intermediary entity is a control plane entity, a user plane entity, or an application entity.

11. The method of claim 1, wherein the capability information on at least one sensorial information comprises information on whether the sensorial information is supported by emitting or detecting sensorial stimuli defined by the sensorial information.

12. The method of claim 1, wherein the sense device manager is a network exposure node or is implemented in or collocated with the network exposure node.

13. The method of claim 1, wherein the sense device manager is implemented as a web portal or a mobile application.

14. The method of claim 1, wherein the sensorial information is smell information or tactile information.

15. The method of claim 1, wherein initiating the action at the user device comprises emitting or detecting the sensorial stimuli associated with the sensorial information.

16. The method of claim 1, wherein the network exposure node is a Network Exposure Function, NEF, the user device is a User Equipment, UE, the control plane node is an Access and Mobility Management Function, AMF, the user plane node is a User Plane Function, UPF, and the application node is an Application Function, AF.

17. A method performed by a sense device manager for handling sensorial information in a communications network, the method comprising:
receiving at a sense device manager from an application node sensorial information, an action associated to the sensorial information, and an indication of a target user device for the sensorial information; and
transmitting from the sense device manager to a user device the sensorial information and the action associated to the sensorial information.

18. The method of claim 17, further comprising:
receiving at the sense device manager from the user device capability information on at least one sensorial information supported by the user device; and
transmitting from the sense device manager to the user device sensorial information based on the capability information transmitted by the user device.

19. The method of claim 17, further comprising:
transmitting from the sense device manager to the application node capability information on at least one sensorial information supported by the sense device manager; and
receiving at the sense device manager from the application node sensorial information based on the capability information transmitted by the sense device manager.

20. The method of claim 17, wherein the sensorial information includes at least one of a type of sense associated with the sensorial information and information defining sensorial stimuli associated with the sensorial information.

21. The method of claim 17, wherein the action associated to the sensorial information indicates to emit or detect the sensorial stimuli defined by the sensorial information.

22. The method of claim 17, wherein the action associated to the sensorial information indicates to transmit to the sense device manager or to the application node a message indicating the emission of the sensorial stimuli or the detection of the sensorial stimuli by the user device.

23. The method of claim 17, wherein the action associated to the sensorial information indicates a policy action or rule to apply to the network traffic of the sensorial information.

24. The method of claim 17, wherein the indication of the target user device comprises at least one of a user device identifier, a user device type, a location of the user device or an area of the user device.

25.-62. (canceled)
